(19) United States
(12) Patent Application Publication
(10) Pub. No.: US 2014/0264101 A1
(43) Pub. Date: Sep. 18, 2014

(54) Device for Controlling the Fluid Supply of a System

(71) Applicant: Bontaz Centre R & D, Marnaz (FR)

(72) Inventors: Stéphane Pascal Perotto, Ayze (FR); Cyrille Yves Salomon, Saint Sigismond (FR); Anthony Raymond Arthur Taupeau, Poisy (FR)

(21) Appl. No.: 14/205,987

(22) Filed: Mar. 12, 2014

(30) Foreign Application Priority Data
Mar. 13, 2013 (EP) 13 305 281.1

(51) Int. Cl. F16K 31/122

(52) U.S. Cl. CPC F16K 31/122
USPC 251/28

(57) ABSTRACT

Device for controlling the supply of a system from a pressurised fluid source comprising an inlet (8), an outlet (10) of pressurised fluid, a main duct (11) connecting the inlet (8) and the outlet (10), and control means comprising:
a secondary duct (12) connecting the supply inlet (8) to the evacuation outlet (10),
a moving sealing element (14) interrupting the flow in the main duct (11),
a sealing device able to interrupt the flow in the secondary duct,
a pilot chamber (18) between the moving sealing element (14) and the sealing means, connected to the inlet (8).

In a closed state of the sealing device, the moving sealing element (14) interrupts circulation of the fluid between the inlet (8) and the outlet (10), and, in an open state of the sealing device, the moving sealing element enables flow between the inlet (8) and the outlet (10).

### TECHNICAL FIELD AND PRIOR ART

The present invention relates to a device for controlling the fluid supply of a system, for example the supply of piston cooling nozzles of an internal combustion engine with oil.

The document FR 2 935 771 describes a device for controlling the fluid supply of a system, particularly implemented for the supply of piston cooling nozzles of an internal combustion engine, comprising a valve provided with a sealing element, the opening of the valve being controlled by a fluid pressure value above a minimum pressure value and the closing of the valve is controlled either by a drop in the pressure below a minimal value, or by the injection of the pressurised fluid on a face of the sealing element so as to cause the closing of the valve. This injection is controlled by an electromagnetic valve. To transport the pressurised fluid in contact on the second face of the sealing element, a secondary channel is formed in the casing. An air vent connected to atmospheric pressure is required at the level of the sealing element to avoid the onset of a pressure opposing the opening of the sealing element.

Said device gives entire satisfaction. The reduction of production costs and a simplification of systems are sought, in particular in the automobile field.

### DESCRIPTION OF THE INVENTION

It is consequently the aim of the present invention to offer a device for controlling the fluid supply of a system, of simplified realisation and offering a reduced production cost compared to control devices of the prior art.

The aforementioned aim is attained by a control device comprising a pressurised fluid supply inlet, an evacuation outlet to the system to be supplied with fluid, a main duct between the supply inlet and the evacuation outlet, a moving sealing element interposed between the inlet and the outlet and able to interrupt or enable communication between the inlet and the outlet via the main duct, a secondary channel connecting the supply inlet and the evacuation outlet, sealing means arranged in the secondary duct able to block off on command said secondary duct, the moving sealing element delimiting in the secondary duct with the sealing means a pilot chamber which is permanently in fluidic communication with the supply inlet. When the sealing means block off the flow in the secondary channel, the fluid applies a strain on the moving sealing element such that it blocks off the main duct. When the sealing means enable flow in the secondary channel, the sealing element moves so as to enable flow in the main channel.

In other words, a control device is formed in which the pressure of the fluid is used to assist the control, which makes it possible to reduce in a substantial manner the size of the actuator of the sealing means. It is possible to implement a sealing element of large size, particularly of important section and/or moving over a considerable stroke while using an actuator for the sealing means of small size, for example an electromagnetic valve of small size.

Moreover, said device is simplified since it does not require an air vent connected to atmospheric pressure.

The control of the sealing element means mounted in the secondary channel may be all or nothing or proportional thereby enabling an opening, a partial opening of the secondary channel to obtain partial opening and closing positions of the control device and thus a modulated supply of the nozzles or any other supplied device.

The subject matter of the present invention is therefore a device for controlling the supply of a system from a pressurised fluid source comprising a pressurised fluid supply inlet, a pressurised fluid evacuation outlet, a main duct connecting the supply inlet and the evacuation outlet, and control means comprising:
a secondary duct connecting the supply inlet to the evacuation outlet,
a moving sealing element able to interrupt the flow in the main duct, said moving sealing element comprising a first end and a second end, the first end of the moving sealing element being intended to be subjected to the pressure of the fluid at the level of the supply inlet, the moving sealing element resting on a valve seat by its first end in a state of interruption of communication between the supply inlet and the evacuation outlet,
sealing means able to interrupt the flow in the secondary duct,
a pilot chamber delimited by the second end of the moving sealing element and the sealing means,
a permanent communication between the pilot chamber and the supply inlet,
   the surfaces of the first and second ends of the moving sealing element on which the pressurised fluid applies and the section of passage of the second portion of the secondary duct are such that, in a closed state of the sealing means, the moving sealing element is maintained in abutment on its valve seat so as to interrupt circulation of fluid between the supply inlet and the evacuation outlet, and, in an open state of the sealing means, the moving sealing element is moved away from its valve seat enabling flow between the supply inlet and the evacuation outlet.

For example, the moving sealing element comprises a through passage connecting its first end to its second end assuring permanent communication between the pilot chamber and the supply inlet.

The sealing means may comprise for example a sealing element and an actuator moving said sealing element between a closed position and an open position and vice versa.

The sealing element may be a control needle valve.

In an embodiment example, the actuator is an all or nothing actuator.

In another embodiment example, the actuator is a proportional actuator.

Advantageously, the sealing means are formed of an electromagnetic valve.

The subject matter of the present invention is also a system for cooling at least one piston of an internal combustion engine comprising at least one control device according to the present invention, the supply inlet of the control device being connected to a pressurised oil source and the evacuation outlet being connected to at least one cooling nozzle.

### BRIEF DESCRIPTION OF THE DRAWINGS

The present invention will be better understood from the description that follows and the appended drawings, in which:

FIG. 1 is a schematic sectional view of a control device according to an embodiment example in a position of non-supply of the nozzles,

FIG. 2 is a schematic sectional view of the device of FIG. 1 in an intermediate position in view of the supply of the nozzles,

FIG. 3 is a schematic sectional view of the device of FIG. 1 in a position of supply of the nozzles,

FIG. 4 is a schematic sectional view of the device of FIG. 1 in a position in view of the interruption of the supply of the nozzles.

### DETAILED DESCRIPTION OF PARTICULAR EMBODIMENTS

In the description that follows, the control device will be applied to the supply of piston cooling nozzles of an internal combustion engine. However the present invention applies to all fields using fluids and requiring a control of their supply. Moreover, for reasons of simplification, the term “oil” will be used to designate the fluid circulating through the control device, but it will be understood that the present invention is not restricted to the supply of oil and that any other fluid may be implemented.

The control device 2 represented in FIGS. 1 to 4 is intended for example to be arranged between a pressurised oil source and at least one cooling nozzle, the pressure source of the oil nozzle being represented schematically. The cooling nozzle is intended to project oil against the bottom of the pistons (not represented) of an internal combustion engine. The control device 2 controls the pressurised oil supply of one or more nozzles.

In the case of the control of the oil supply of the nozzles, the control device is intended to be fixed on the crankcase.

The control device comprises a supply inlet 8, designated hereafter inlet, and an evacuation outlet 10, designated hereafter outlet. The inlet 8 is intended to be connected to the pressurised oil source (not represented), for example an oil pump, and the outlet 10 is intended to be connected to at least one cooling nozzle (not represented). The inlet 8 and the outlet 10 are connected by a main duct 11.

The control device further comprises, interposed between 8 and the outlet 10, means for controlling the fluidic communication between the inlet 8 and the outlet 10.

The control means are arranged in the main duct 11 between the inlet 8 and the outlet 10 so as to control communication between the inlet 8 and the outlet 10. The control means comprise a secondary duct 12 connecting the inlet 8 and the outlet 10, sealing means 16 arranged in the secondary duct 12, delimiting a first portion 12.1 situated between the inlet 8 and the sealing means 16 and a second portion 12.2 situated between the sealing means 16 and the evacuation outlet 10.

The control means comprise a moving sealing element 14 in translation in the first portion 12.1, the moving sealing element 14 being intended to rest on a valve seat 17 lining the inlet 8. The moving sealing element 14 has a longitudinal axis X and is moveable along its longitudinal axis in the first portion 12.2.

A pilot chamber 18 is arranged between the moving sealing element 14 and the sealing means 16.

The pilot chamber 18 is permanently in communication with the inlet 8. In the example represented, the moving sealing element 14 comprises a passage 20 assuring permanent communication between the inlet 8 and the pilot chamber 18. In the example represented, the passage is coaxial to the axis of the moving sealing element 14, but it could also be offset with respect to the axis of the sealing element.

The second portion 12.2 of the secondary duct 12 is such that the flow rate of the pilot chamber 18 to the outlet 10 is greater than that of the inlet 8 to the pilot chamber 18. For example, the section of passage of the second portion 12.2 of the secondary duct 12 is greater than that of the passage through the moving sealing element 14.

The sealing means 16 are, in the example represented, formed of a control needle valve moveable in translation by an actuator. The sealing means may for example be formed of an electromagnetic valve. All means making it possible to interrupt or enable flow on command may be implemented. For example, it is possible to envisage implementing a valve actuated by a piezoelectric or pneumatic actuator. In other applications, manual control sealing means may be envisaged.

The moving sealing element 14 comprises a first longitudinal end 14.1 subjected to the pressure of the fluid at the inlet 8, and a second longitudinal end 14.2 subjected to the pressure of the fluid in the pilot chamber 18. The surface of the second longitudinal end 14.2 seeing the pressurised oil is greater than the surface of the first longitudinal end 14.1 seeing the pressurised fluid such that, when the same pressure exists at the inlet 8 and in the pilot chamber 18, the moving sealing element 14 is pushed back against its seat 17 and interrupts communication between the inlet 8 and the outlet 10.

In the example represented, the first end 14.1 has a truncated cone shape, and the surface of the first end 14.1 of the sealing element seeing the fluid when the sealing element is moved away from its seat is the same surface as that of the second end of the sealing element. However, due to the flow of oil and head losses, the pressure in the main duct 11 is less than that in the pilot chamber 18 which is at the pressure of the inlet 8. A sealing element having another shape does not go beyond the scope of the present invention.

The operation of the control device according to the invention will now be described.

In the application to the supply of cooling nozzles, the control device is normally open (state represented in FIG. 3), enabling supply of the nozzles. For other applications, it may be in a normally closed state, the supply being interrupted.

In a position of interruption of the supply as represented in FIG. 1, the needle valve 16 interrupts flow from the pilot chamber 18 to the second portion 12.2 of the secondary duct 12. On account of the permanent communication between the inlet 8 and the pilot chamber 18 and the closed state of the needle valve, the oil pressure in the pilot chamber 18 is equal to the oil pressure at the inlet 8. The surface of the second longitudinal end 14.2 of the moving sealing element 14 on which the oil of the pilot chamber 18 applies being greater than the surface of the first longitudinal end 14.1 of the moving sealing element 14 on which the oil applies at the inlet 8, the force exerted by the oil in the pilot chamber 18 on the moving sealing element 14 presses the moving sealing element 14 against the valve seat 17. Communication between the inlet 8 and the outlet 10 is thereby interrupted. The nozzles are not supplied with oil.

When it is wished to supply the cooling nozzle with oil, the control needle valve is slid so as to enable communication between the pilot chamber 18 and the second portion 12.2 of the secondary duct (FIG. 2). This communication causes flow of the fluid contained in the pilot chamber to the outlet 10 via the second portion 12.2. Furthermore, the flow rate through the second portion 12.2 is greater than that of the inlet 8 in the pilot chamber 18, the pressure in the pilot chamber 18 drops due to the flow through the second portion 12.2 in the direction of the evacuation outlet 10, and thus the pressure drops, going from the inlet pressure to the outlet pressure. The oil pressure at the level of the supply inlet 8 applying on the first end of the moving sealing element is then greater than that applying on the second end of the moving sealing element 14 in the pilot chamber 18 and is such that force applied on the first longitudinal end 14.1 of the moving sealing element 14 by the pressurised oil is greater than that applied on the second longitudinal end 14.2 of the moving sealing element 14 by the oil contained in the pilot chamber 18, the moving sealing element 14 then slides in the first zone 12.1 of the secondary duct 12 in a sense of reducing the volume of the pilot chamber 18. The moving sealing element moves away from the valve seat 17 due to dynamic pressure and static pressure, thereby enabling flow of the oil from the supply inlet 8 to the supply outlet 10 via the main duct 11 (FIG. 3).

When it is decided to interrupt the oil supply of the nozzles, the control needle valve is slid so as to again interrupt communication between the first portion 12.1 and the second portion 12.2 of the secondary duct 12 (FIG. 4). The pilot chamber 18 is always supplied with oil via the passage through the moving sealing element 14, but the oil is no longer evacuated via the second portion 12.2. The pressure in the pilot chamber 18 increases until it reaches the value of the pressure at the supply inlet 8. Due to the flow of oil and head losses, the pressure in the main duct 11 is less than that in the pilot chamber 18 which is at the pressure of the inlet 8, a force applies on the moving sealing element 14 in the direction of its valve seat 17 thereby reducing the passage of the fluid until it interrupts it completely. The flow between the supply inlet 8 and the evacuation outlet 10 is then again interrupted (FIG. 1).

In the example described, the opening and the closing of the sealing means are all or nothing, but partial opening or partial closing of communication between the pilot chamber 18 and the second portion 12.2 of the secondary duct 12 may be provided by providing proportional opening means of the sealing means.

Thanks to the invention, a moving sealing element of large size and/or having an important stroke may be implemented while conserving sealing means having a very small stroke and size, since the control of the sealing element is assisted by the pressure in the pilot chamber. The control device may then have great compactness.

Moreover, the control device is of simplified realisation, since it only requires a secondary channel between the supply inlet and the evacuation outlet and does not require an air vent to atmospheric pressure. Its production cost is reduced.

Furthermore, said device is very easy to integrate in existing cooling circuits.

The supply control device is particularly adapted to the control of the supply of one or more piston cooling nozzles for internal combustion engines. But it will be understood that the control device according to the present invention may be adapted to all systems implementing fluids and requiring control of the fluid supply.

1. Control device for controlling the supply of a system from a pressurised fluid source comprising a pressurised fluid supply inlet, a pressurised fluid evacuation outlet, a main duct connecting the supply inlet and the evacuation outlet, and control means comprising:
a secondary duct connecting the supply inlet to the evacuation outlet,
a moving sealing element able to interrupt the flow in the main duct, said moving sealing element comprising a first end and a second end, the first end of the moving sealing element being intended to be subjected to the pressure of the fluid at the level of the supply inlet, the moving sealing element resting on a valve seat by its first end in a state of interruption of the communication between the supply inlet and the evacuation outlet,
a sealing device able to interrupt the flow in the secondary duct,
a pilot chamber delimited by the second end of the moving sealing element and the sealing means,
a permanent communication between the pilot chamber and the supply inlet,
the surfaces of the first and second ends of the moving sealing element on which the pressurised fluid applies and the section of passage of the second portion of the secondary duct are such that, in a closed state of the sealing device, the moving sealing element is maintained in abutment on its valve seat so as to interrupt the circulation of fluid between the supply inlet and the evacuation outlet, and, in an open state of the sealing device, the moving sealing element is moved away from its valve seat enabling flow between the supply inlet and the evacuation outlet.

2. Control device according to claim 1, in which the moving sealing element comprises a through passage connecting its first end to its second end assuring permanent communication between the pilot chamber and the supply inlet.

3. Control device according to claim 1, in which the sealing device comprises a sealing element and an actuator moving said sealing element between a closed position and an open position and vice versa.

4. Control device according to claim 1, in which the sealing element is a control needle valve.

5. Control device according to claim 3, in which the actuator is an all or nothing actuator.

6. Control device according to claim 3, in which the actuator is a proportional actuator.

7. Control device according to claim 4, in which the actuator is an all or nothing actuator.

8. Control device according to claim 4, in which the actuator is a proportional actuator.

9. Control device according to claim 1, in which the sealing device is formed of an electromagnetic valve.

10. System for cooling at least one piston of an internal combustion engine comprising at least one control device according to claim 1, the supply inlet of the control device being connected to a pressurised oil source and the evacuation outlet being connected to at least one cooling nozzle.
